(19) United States
(12) Patent Application Publication
(10) Pub. No.: US 2003/0110178 A1
(43) Pub. Date: Jun. 12, 2003

(54) Method and system of tracking medical films and associated digital images for computer-aided and diagnostic analysis

(75) Inventors: Kevin S. Woods, Tampa, FL (US); Maha Yousef Sallam, Tampa, FL (US); Greg Gustafson, Maple Plain, MN (US)

Correspondence Address: MORGAN LEWIS & BOCKIUS LLP, 1111 PENNSYLVANIA AVENUE NW, WASHINGTON, DC, 20004, US

(73) Assignee: icad, inc.

(21) Appl. No.: 10/292,514

(22) Filed: Nov. 13, 2002

Related U.S. Application Data
(60) Provisional application No. 60/331,784, filed on Nov. 21, 2001.

(51) Int. Cl. G06F 7/00

(52) U.S. Cl. 707/100

(57) ABSTRACT

A method and system for tracking medical images and associated digital images for diagnostic evaluation. The system includes a scanner for digitizing one or more medical images defining a case to thereby produce one or more digitized medical images and for reading a machine-readable tracking identifier attached to each medical image of the case. A server associates the tracking identifier with one or more digitized medical images and one or more computer-aided diagnostic (CAD) images, wherein the one or more CAD images correspond to the one or more digitized medical images that are processed using a CAD algorithm. The system stores the associated tracking identifier, the one or more digitized medical images, and the one or more CAD images in a storage device. The server receives and processes a medical image request including the tracking identifier to retrieve at least one of the one or more digitized medical images or the one or more CAD images from the storage device using the tracking identifier.

### BACKGROUND OF THE INVENTION

This application claims the benefit of a provisional application entitled “Method and System of Tracking Medical Films and Associated Digital Images for Computer-Aided and Diagnostic Analysis,” that was filed Nov. 21, 2001 and assigned Provisional Application No. 60/331,784, which is hereby incorporated by reference.

A. Field of the Invention

The present invention relates to a method and system for processing medical films and for tracking associated digital images, and more particularly, to a method and system for tracking a patient's radiological study for computer-aided analysis and clinical review.

B. Background

With the development of more sophisticated and refined computer-aided detection (CAD) techniques capable of identifying suspicious abnormalities in a radiological image, the diagnostic evaluation of the original radiological films usually includes the review of the output from one or more CAD schemes. While evaluating a patient's radiological films on a lightbox or similar viewing device the radiologist will retrieve and display the CAD results on one or more monitors. The CAD results aid the radiologist in the proper evaluation of the original radiological films. Various CAD techniques have been developed to aid medical personnel in the diagnostic evaluation of radiological images.

Typically, a series or set of standard X-ray images, often referred to as a study, are produced of a particular anatomical structure. The X-ray films are then digitized and analyzed using one or more CAD techniques. The output from the image processing routines is usually stored in a database for subsequent retrieval and evaluation. Thus, the radiologist is able to retrieve and display the CAD results associated with the patient's study. Depending on the particular application, CAD analysis may be performed to identify suspicious structures or features in the radiological image.

For example, in the field of digital mammography, CAD techniques have been developed to detect suspicious masses, lesions, and calcifications. The results of the CAD analysis are often highlighted or indicated on the displayed image. For example, the CAD system may outline a region of interest in a digital mammogram or the system may use a symbol, such as a hash mark or square, to indicate a feature that may deserve increased scrutiny by the radiologist. Therefore, by identifying abnormalities in the mammogram, the CAD results may assist the radiologist in evaluating the original radiological films.

However, current methods and systems for processing and tracking a patient's study for analysis and review have numerous drawbacks or shortcomings. For example, current CAD systems for processing and tracking radiological films for subsequent CAD analysis are cumbersome. To process and enter a patient's study into a tracking system, some CAD systems require that the radiological films be scanned in a pre-defined order. In the context of a typical mammographical study consisting of four images (e.g., RMLO, RCC, LMLO, LCC) a medical technician must place the films into the scanner of the CAD systems in a particular order. Otherwise, the films would not be properly identified and tracked by the CAD system.

Furthermore, to scan and begin tracking a batch of mammograms, some CAD systems can only process a batch of mammograms that have the same dimensions. For instances, standard film sizes used in digital mammography measure 8 in.×10 in. or 10 in.×12 in. To process a patient's study having different image sizes or to batch process multiple studies having different image sizes, a medical technician must monitor the scanning operation and adjust the film guides of the scanner accordingly. Therefore, current methods and systems for processing mammograms and recording the mammograms in the tracking system of the CAD system are inefficient, time consuming, and prone to error.

Finally, during the evaluation or review of the original radiological films, current CAD systems do not provide a simple and efficient method of retrieving and displaying associated CAD results. One current technique requires that the CAD results be printed and distributed along with the original radiological films to the reviewing radiologist. Using each separate printout, the radiologist may retrieve and display the corresponding image. However, the printing and distribution of the CAD results for each film requires additional physical (i.e., paperwork) and human resources. Another technique requires a medical technician to preprogram the viewer so that the system knows which film (or set of films) is on which frame of the viewer.

In light of the foregoing, to aid the radiologist in the accurate interpretation of a patient's study, there is a need for a reliable and efficient method and system for processing radiological films and for tracking any associated CAD analysis. In other words, medical personnel should be able to easily scan the radiological films of a patient's study and track the study as it is analyzed using one or more CAD routines, thereby ensuring that the CAD results are associated with the proper radiological films. Moreover, when evaluating a patient's study, there is a need for a method and system that enables a radiologist to reliably retrieve and display the CAD results associated with radiological films of the particular study.

### SUMMARY OF THE INVENTION

Accordingly, the present invention is directed to a method and system for processing medical images and for tracking associated digital images that substantially obviates one or more of the problems due to limitations and disadvantages of the related art.

To achieve these and other advantages and in accordance with the purpose of the present invention, as embodied and broadly described, in one aspect of the present invention there is provided a system for tracking medical images and associated digital images for diagnostic evaluation. The system includes a scanner for digitizing one or more medical images defining a case to thereby produce one or more digitized medical images and for reading a machine-readable tracking identifier attached to each medical image of the case; a server for associating the tracking identifier with one or more digitized medical images and one or more computer-aided diagnostic (CAD) images, wherein the one or more CAD images correspond to the one or more digitized medical images that are processed using a CAD algorithm; and a storage device for storing the associated tracking identifier, the one or more digitized medical images, and the one or more CAD images, wherein the server receives and processes a medical image request including the tracking identifier to retrieve at least one of the one or more digitized medical images or the one or more CAD images from the storage device using the tracking identifier.

In another aspect, the present invention provides a method for scanning and tracking medical images using a scanning system. The method includes receiving one or more medical images, wherein each medical image has a machine-readable label containing at least one tracking identifier; scanning the one or more medical images and the at least one tracking identifier, whereby said medical image is digitized and the at least one tracking identifier on said machine-readable label is read; associating the at least one tracking identifier with the digitized medical image; and storing the at least one tracking identifier and the digitized medical image in at least one storage device.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing an integrated system for scanning mammograms and reviewing CAD results according to one exemplary embodiment of the present invention;

FIG. 2 is a block diagram showing in more detail the reviewer workstation depicted in FIG. 1;

FIG. 3 is a flowchart showing an exemplary process for producing and evaluation radiological films;

FIG. 4 is a flowchart showing a general overview of a method for processing, tracking, and retrieving mammograms according to one exemplary embodiment of the present invention;

FIG. 5 graphically illustrates portions of the method for tracking a patient's mammographic study shown in FIG. 4;

FIG. 6 is a exemplary user interface for inputting tracking information into the tracking system according to a exemplary embodiment of the present invention;

FIGS. 7A-7C show exemplary labels for one exemplary embodiment of the present invention;

FIG. 8 is a diagram showing an exemplary label attached to a mammogram according to one exemplary embodiment of the present invention;

FIG. 9 is a schematic diagram showing an exemplary method of scanning mammograms with labels according to one exemplary embodiment of the present invention;

FIG. 10 is an exemplary display window showing the status of the processing of a patient's study according to one exemplary embodiment of the present invention;

FIG. 11 is an exemplary display window showing tracking information for multiple patient studies according to one exemplary embodiment of the present invention;

FIG. 12 is a schematic diagram showing an exemplary reviewer workstation according to one exemplary embodiment of the present invention;

FIG. 13 is an exemplary output display showing images retrieved according to one exemplary embodiment of the present invention; and

FIG. 14 is a flowchart showing an exemplary method for tracking a patient's mammographic study according to one exemplary embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like elements.

A. System Hardware

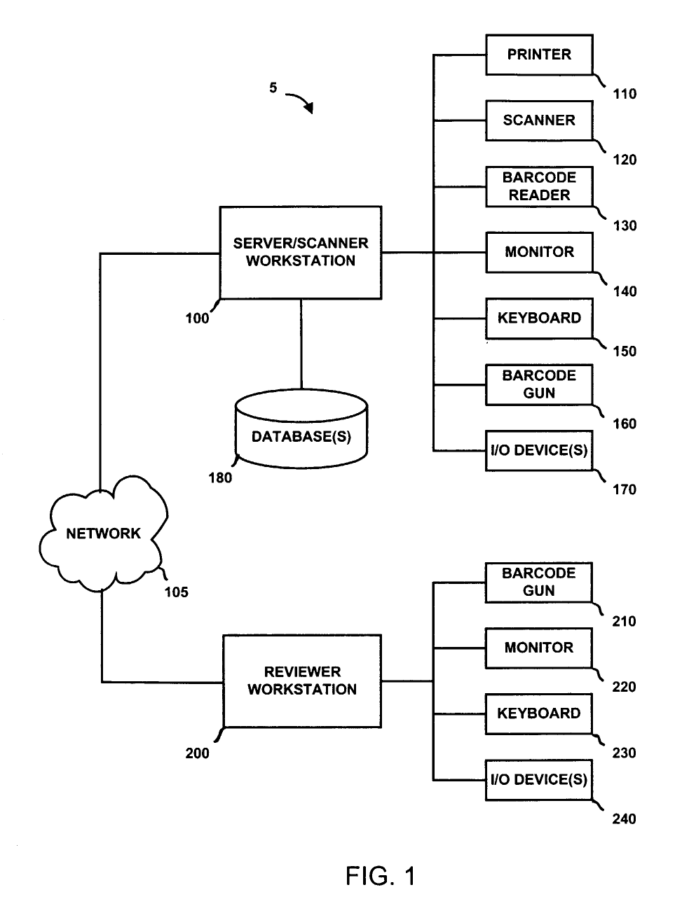

FIG. 1 is a block diagram of an exemplary system 5 for implementing the tracking method and system according to one embodiment of the present invention. Specifically, the present embodiment shows an exemplary CAD system 5 for detecting abnormalities in digital mammograms. The CAD system 5 may comprise a server/scanner workstation 100, a common database 180, and a reviewer workstation 200, among other components, connected through a network 105. The server/scanner workstation and reviewer workstation may be connected to permit communications with the common database 180, and possibly each other, through network 105. For example, network 105 may be a local area network (LAN), a wide area network (WAN), such as the Internet, or another network, or a combination of networks (e.g., LAN and WAN). For example, the server/scanner workstation 100 may be embodied by a scanner workstation and a server workstation connected through a LAN or WAN. The arrangement shown in FIG. 1 is intended as an example. Various alternatives are possible.

As noted above, FIG. 1 shows the server/scanner workstation 100 as a single block, but it should be understood that the server and scanner may be separate devices that are connected directly or connected via a network, such as network 105.

Components on LAN may be connected together through twisted pair, coaxial cable, or fiber media, through wireless links, or through a combination of wired and wireless links. Any LAN topology may be used, for example, a line, a ring (such as a token ring), a star, a bus, a mesh or another topology or combination of topologies.

Data may be transferred between components of the LAN or WAN in packets, i.e., blocks of data that are individually transmitted over the LAN or WAN. Routers may connect the LAN components to other computer networks, such as the Internet, other LANs or WAN. Routers are hardware devices that may include a conventional processor, memory, and separate I/O interface for each network to which it connects. Hence, components on the expanded network may share information and services with each other. Therefore, the sever/scanner workstation 100 and the reviewer workstation 200 may store and access information on other networks.

In order for communications to occur between components of physically connected networks, all components on the expanded network and the routers that connect them must adhere to a standard protocol. Computer networks connected to the Internet and to other networks typically use TCP/IP Layering Model Protocol. It should be noted that other internetworking protocols may be used.

The server/scanner workstation 100 and reviewer workstation 200 may access information in a database on a common storage device 180, such as a hard disk or optical disk. Database 180 may reside at the server/scanner workstation, the reviewer workstation, or at a separate system (not shown). In one exemplary embodiment, database 180 resides at server/scanner workstation 100. Therefore, as discussed above, using a LAN connection the reviewer workstation 200 may access and store information on database 180. As one skilled in the art will appreciate, the workstations may alternatively have separate storage devices 180 for maintaining data and manipulating data.

Implementation of the present invention is not limited to the specific hardware configuration shown in FIG. 1. Instead, those skilled in the art will appreciate that the method and system of the present invention may be advantageously implemented in a variety of configurations. For example, the CAD system 5 may comprise of one workstation or multiple workstations with different tasks and functions dispersed across various platforms. Moreover, the workstations shown in FIG. 1 need not be connected via a network. Data may be transferred between the workstations using removable media, such as a CD-ROM, PC-CARD, floppy disk, magnetic tape, and optical medium.

The server/scanner workstation 100 and reviewer workstation 200 may each have one or more attached external devices. As shown in FIG. 1, server/scanner 100 may include, for example, a printer 110, a scanner 120, a barcode reader 130, a monitor (e.g., cathode ray tube, liquid crystal display, plasma display, etc.) 140, a keyboard 150, a barcode gun 160, and one or more other I/O devices 170. Further, reviewer workstation 200 may include a barcode gun 210, a monitor 220, a keyboard 230, and one or more other external devices 240. As one skilled in the art will appreciate, the workstations may also include one or more other input/output devices including, but not limited to, a mouse, a pointer, speaker(s) and microphone.

The server/scanner workstation 100 may also be connected directly or indirectly to one or more imaging acquisition devices (not shown) that may include, but is not limited to, an imaging device used to produce X-ray mammograms, magnetic resonance imager, positron emission tomographic imager, CT scanner, ultrasonic imager, or other imaging equipment. The imaging device may be controlled by server/scanner workstation 100 or by another computer system.

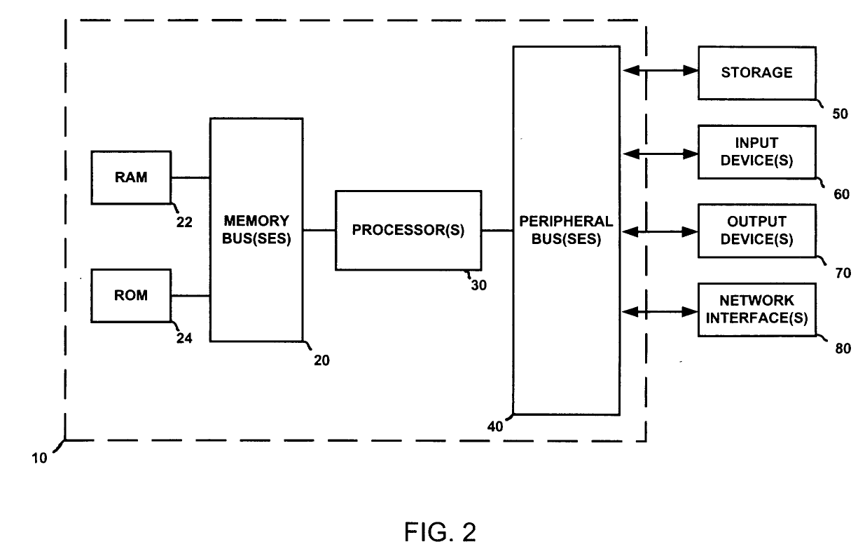

FIG. 2 is a block diagram of an exemplary computer system 10 for carrying out the functions or operations of the server/scanner workstation 100 and/or reviewer workstation 200 according to one embodiment of the present invention. The computer system 10 comprises a processor 30, such as a microprocessor, a central processing unit (CPU), or parallel processor, memory bus 20, random access memory (RAM) 22, read only memory (ROM) 24, peripheral bus 40, and various input/output devices, as discussed above. The processor 30 may be a general purpose digital processor which controls the operation of the computer system 10. Using instructions retrieved from memory, the processor 30 controls the reception and manipulation of input data and the output and display of data on output devices 70.

Each of memory bus 20 and peripheral bus 40 may be formed of one or more buses of one or more types. The memory bus 20 may be used by the processor 30 to access the RAM 22 and the ROM 24. The RAM 22 may be used by the processor 30 as a general storage area and as storage for input data and processed data. The ROM 24 may be used to store instructions or program code followed by the processor 30 as well as other data. The peripheral bus 40 is used to access the storage devices 50, input devices 60, and output devices 70 used by the computer system 10. The processor 30 together with an operating system execute computer code and produce and use data.

The computer code and data may reside in RAM 22, ROM 24, or in external storage 50, or even on another computer connected via a network or a combination of the foregoing. The computer code and data could also reside on a removable program medium and loaded or installed onto the computer system 10 when needed. Removable program mediums include, for example, CD-ROM, PC-CARD, floppy disk, magnetic tape, and optical media. A network interface 80 may be used to send and receive data over a network connected to other computer systems. An interface card or similar device and appropriate software implemented by the processor 30 can be used to connect the computer system 10 to an existing network and transfer data.

Implementation of the server/scanner workstation 100 or reviewer workstation 200 is not limited to the specific hardware configuration shown in FIG. 2. Instead, those skilled in the art will appreciate that the method and system of the present invention may be advantageously implemented using a variety of computer systems.

B. System Software

The software of the present invention implemented on computer system 10 can be written in any suitable computer language. In the present embodiment, the software is written using the C++programming language.

C. General Overview

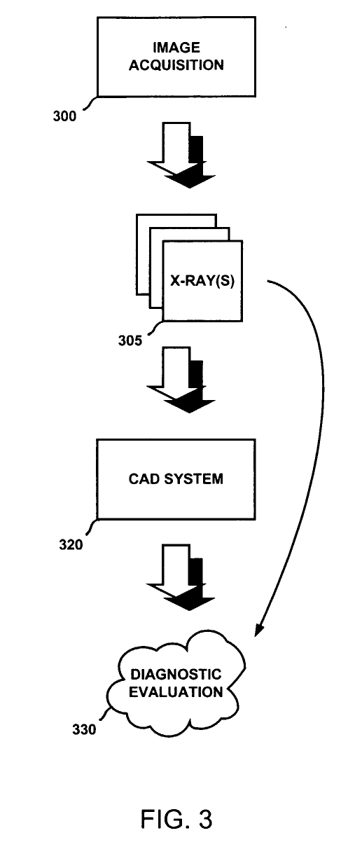

FIG. 3 is a flow diagram showing an exemplary implementation of one embodiment of the present invention. In other words, FIG. 3 shows the general procedure for creating, analyzing, and evaluating a patient's radiological study. To assist the radiologist in the diagnostic evaluation of the original radiological films, the films are analyzed using one or more CAD techniques. Therefore, while reviewing the patient's films for abnormalities according to conventional radiological interpretive techniques, the radiologist may also consider the results of the CAD analysis. This clinical process is depicted in FIG. 3. While FIG. 3 is described, by way of example, in the context of X-ray films, it should be understood that other images from other images from other imaging modalities may be used.

Namely, at step 300 of FIG. 3, using a conventional image acquisition technique known in the art, X-ray films 310 are produced. Typically, a set or series of films, often referred to as a study, are produced of a specific anatomical structure. In the field of mammography, a radiological study typically entails the exposure of four X-ray films that contain four different views of the breast region. The four views are commonly identified as RMLO, RCC, LMLO, and LCC views. Using a properly configured CAD system 320, the X-rays 310 are scanned and analyzed. Specifically, the X-rays 310 are converted by the CAD system 320 into digital images that are then stored in one or more databases that may be connected to the CAD system 320.

A technician may then direct the CAD system 320 to analyze one or more of the digital mammograms for abnormalities. The CAD analysis may be stored in one or more databases for subsequent retrieval and evaluation. To aid the radiologist in the diagnostic evaluation of the patient's study, many radiologists will contemporaneously retrieve and review the CAD results associated with corresponding X-ray films 305. Using the method and system of the present invention, the radiologist may easily retrieve and display the CAD results on one or more monitors. Therefore, the radiologist is able to efficiently utilize the CAD results for purposes of identifying suspicious abnormalities in the X-ray mammograms 305.

D. Method Overview

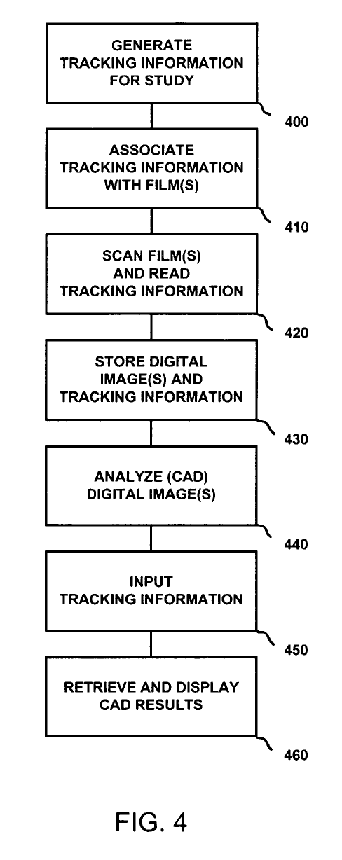

FIG. 4 shows a general overview of a method for tracking and managing mammographic studies for analysis according to one embodiment of the present invention. To provide a reliable method and system for processing radiological films and for properly associating the films with corresponding CAD analysis, the system first generates tracking information for a particular study. The present embodiment will be described in the context of a mammographic study consisting of four X-ray mammograms. However, the present invention is not limited to mammographic studies, X-ray studies, or studies having only four films. A mammographic study may comprise of any number of X-ray mammograms. For example, a particular study may consist of only one X-ray mammogram.

After tracking information has been generated at step 400 of FIG. 4, the tracking information is associated with each film of the study at step 410. The tracking information may be manually or automatically applied to the X-ray mammograms. Next, the X-ray mammograms along with the tracking information are scanned at step 420—the X-ray mammogram is digitized and the tracking information is read by a scanner.

The tracking information read from the X-ray mammograms is stored along with the digitized images in one or more databases at step 430. To analyze the digital images, the system may execute one or more CAD routines at step 440. Depending on the system's particular capabilities and available routines, the user may instruct the system to analyze the digital images for abnormalities, such as suspicious masses, lesions, and calcifications. Using the tracking information read during the scanning operation, the output from the CAD routines are associated with the corresponding X-ray mammogram. Thus, the output from multiple CAD routines may be reliably associated with the proper X-ray mammogram.

After the digital mammograms have been analyzed and the results of the CAD routines stored, a radiologist will then interpret the original films and the CAD results. The radiologist will evaluate the four X-ray mammograms using a conventional lightbox or one or more monitors. To improve the accuracy of the diagnostic evaluation of the films, the radiologist will usually retrieve the CAD results for one or more of the films. The radiologist may input the tracking information from any one of the four X-ray mammograms into the system at step 450. Using the tracking information at step 460, the system can retrieve and display the CAD results for one or more of the films of the study. So that the radiologist may efficiently review the original films and the CAD results, the system displays the digital results on one or more monitors attached to the reviewer workstation.

E. Detailed Method

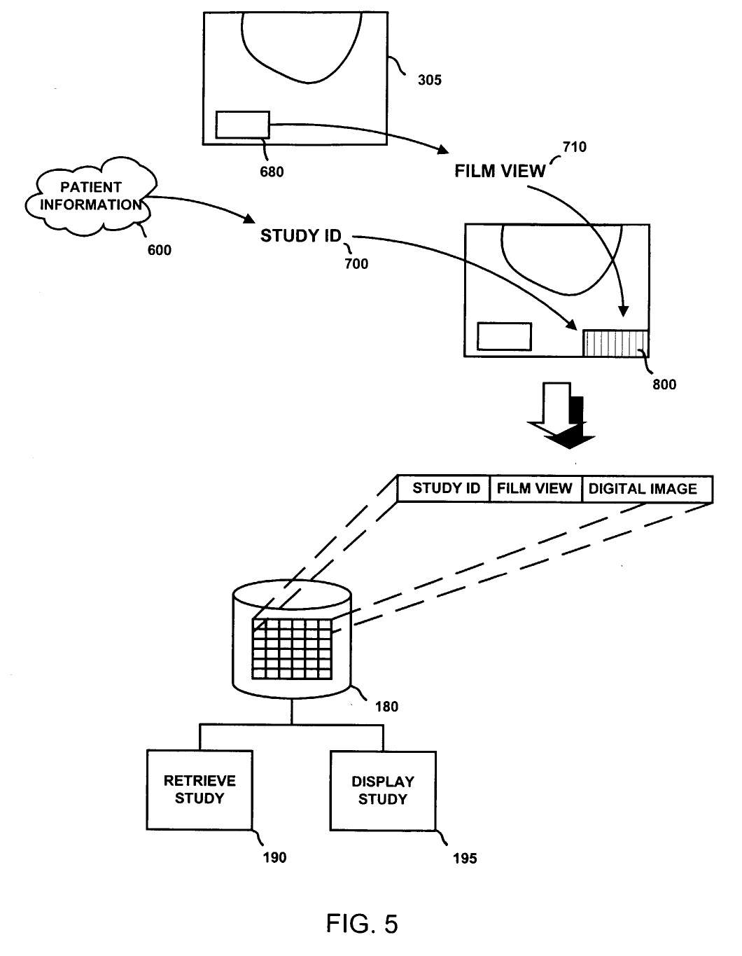

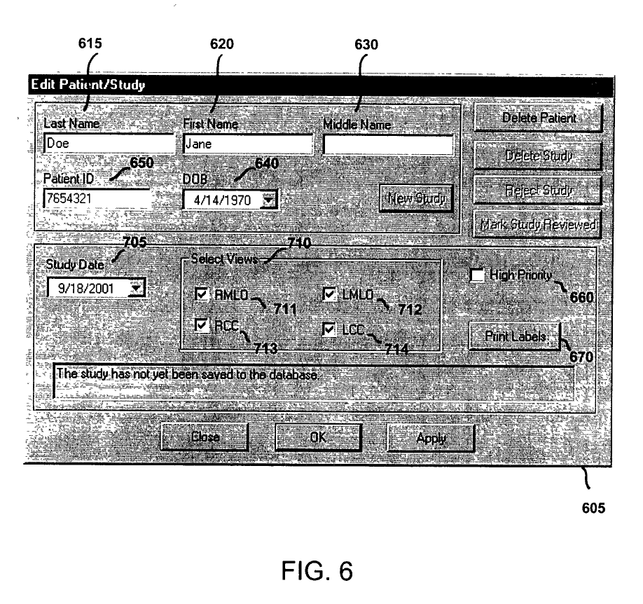

FIG. 5 graphically depicts portions of a method for tracking a patient's mammographic study, according to one embodiment of the present invention. After one or more X-ray mammograms 305 have been produced, patient information 600 may be entered and stored in database 180 of the system. As one skilled in the art will appreciate, the patient data 600 may be entered manually or automatically. FIG. 6 shows an exemplary user interference 605 for inputting patient data 600 into the system according to one embodiment of the present invention.

As shown in FIG. 6, patient information 600 may include, but is not limited to, the patient's last name 615, first name 620, middle name 630, and date of birth 640. Moreover, a pre-defined Patient ID 650 may be assigned to the patient and entered into the system. Besides conventional patient information 650, other information including information about the study may be entered and tracked by the system of the present embodiment. As shown in the exemplary input screen in FIG. 6, the user may also input the date 705 the study was conducted, the priority 660 assigned to the study, and the Film Views 710 of the X-ray mammograms that constitute the study. The image view is usually indicated on the original X-ray mammogram e.g., in flasher 680 shown in FIG. 5). Thus, if the study consists of the four traditional mammographic views, then the user would select RMLO 711, LMLO 712, RCC 713, and LCC 714 shown in FIG. 6. If the study has fewer than the four standard views, then the user may deselect the missing view(s).

Referring to FIG. 5, the system then generates tracking information to identify the study. In this scenario, the system automatically generates a Study ID 700 that may be associated and stored with the patient's information 600. The Study ID 700 may consist of, but is not limited to, alpha-numeric values. As illustrated in FIG. 5, the Study ID 700 and the Film View 710 are associated with the X-ray. This may be accomplished in any number of different ways. For example, in one embodiment the server/scanner workstation may be configured to print labels containing the Study ID 700 and Film View 710. The exemplary user interface input screen 605 in FIG. 6 shows a “print labels” 670 button for initiating this operation in the present embodiment.

If a study consists of four mammograms representing four different views, the system would preferably print four labels. A label containing the Study ID 700 and the particular Film View 710 would be printed for each X-ray mammogram 305. Therefore, after the patient's information 600 and view types have been entered, and a unique Study ID 700 has been automatically generated, the system may print labels on a printer attached to the server/scanner workstation. As one skilled in the art will appreciate, the labels may also be prepared using a separate system.

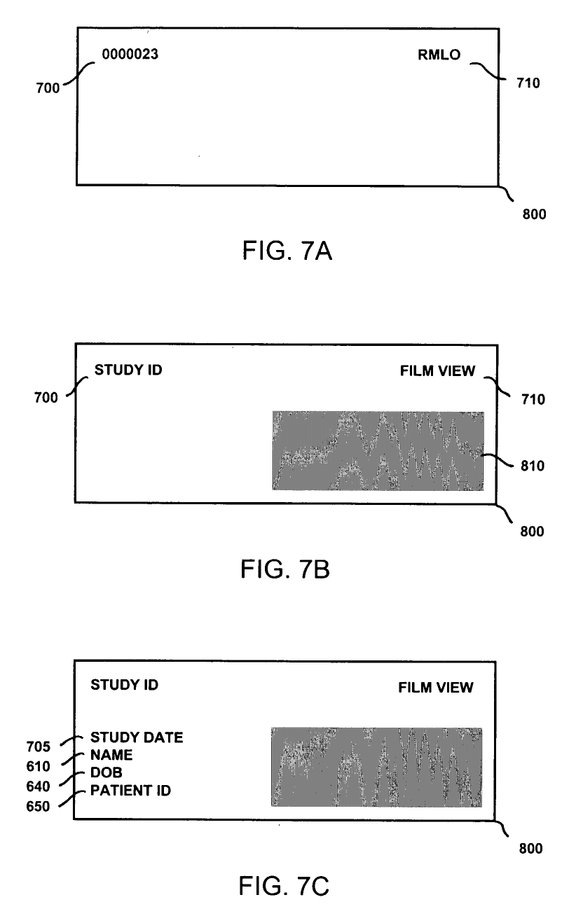

FIGS. 7A-7C show exemplary labels according to one embodiment of the present invention. FIG. 7A shows a label 800 with numeric Study ID 700 and Film View 710 RMLO. Of coarse, the Film View 710 may be indicated by a numerical designation, a symbol, or any other naming methodology. Alternatively, the Study ID 700 and Film View 710 may be encoded in a barcode 810 or other machine-readable code shown in the exemplary label illustrated in FIG. 7B. The type of scanner used to read the labels 800 during the scanning of the X-ray mammograms will dictate the method and format in which the Study ID 700 and Film View 710 are represented on the label 800. For example, FIG. 7B shows a label 800 suited for a barcode scanner.

As one skilled in the art will appreciate, various label 800 and scanner reading methods may be implemented in accordance with the present embodiment of the invention. For example, a character-recognition scanner may be used to read the label 800 shown in FIG. 7A. Moreover, the Study ID 700 and Film View 710 information may be digitized along with the breast image and then identified and interpreted using software techniques known in the art.

As shown in FIG. 7C, besides the Study ID 700 and the Film View 710 identifiers, the label 800 may contain additional information, such as the study date 705, the patient's name 610 and date of birth 640, and a Patient ID 650. The additional identifying information may aid medical personnel in the handling and tracking of the films 305. Furthermore, when reviewing the X-ray mammogram 305, the radiologist may also use the other identifying information printed on the label to retrieve CAD results associated with a particular study.

In the present embodiment, as shown in FIG. 5, a printed label 800 containing the Study ID 700 and Film View 710 is attached to each X-ray mammogram 305. Using the Film View 710 information printed on the labels 800, each label 800 should be properly matched and applied to the appropriate X-ray mammogram 305. For example, a label 800 with the Film View 710 of RMLO should be matched and attached to the X-ray mammogram accordingly marked.

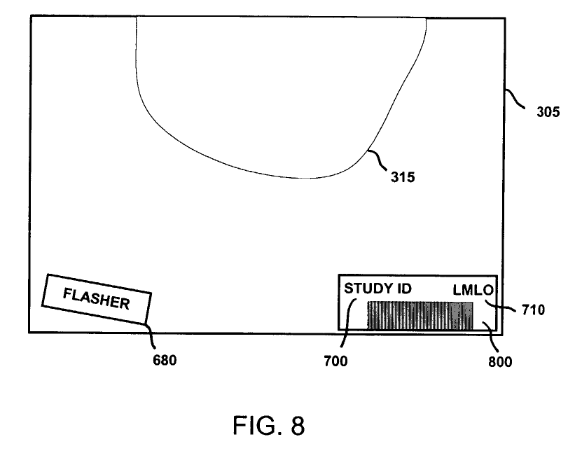

In the present embodiment, which utilizes barcode scanners to read the labels applied to the X-ray mammograms 305, the label 800 should be attached near the bottom right edge of the film 305 (i.e., the opposite side of the flasher 680), when the X-ray mammogram 305 is viewed (glossy side up) with the breast image 315 pointing down. See FIG. 8. The barcode 810 should be adjacent to the edge of the film 305. The labels 800 may be manually or automatically applied to each X-ray mammogram of the study. Also, one skilled in the art will appreciate that the orientation of the label 800 on each film 305 may vary depending on the scanner configuration. Different scanner configurations will be discussed in more detail below.

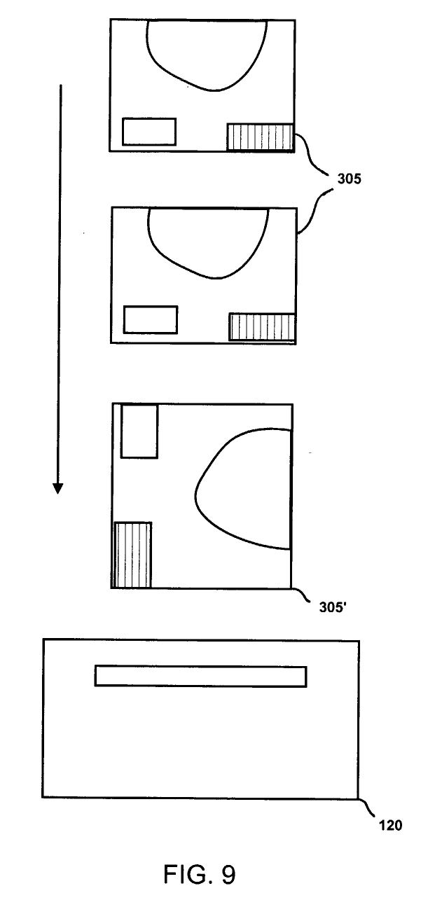

Once the Study ID 700 and Film View 710 have been associated with an X-ray mammogram, the films 305 are scanned. One advantage of the present embodiment is that different film sizes may be loaded into a hopper of a scanner and processed without adjusting the guides of the scanner. Therefore, multiple mammograms or multiple studies may be loaded and efficiently scanned without significant monitoring by a technician. For example, FIG. 9 shows the processing of two 8 in.×10 in. X-ray mammograms 305 and one 10 in.×12 in. X-ray mammogram 305′, according to one embodiment of the present invention.

Larger films 305′ are preferably loaded into the scanner's hopper (not shown) with the label 800 at the lower left comer. While the smaller films 305 are loaded so that the label 800 is positioned at the lower right. As a result, a technician need not adjust the film guides of the scanner 120 to accommodate the different film sizes. In the present embodiment, scanner 120 includes two barcode readers (not shown) for reading labels 800. The first barcode reader is positioned to scan the barcode 810 printed on the labels 800 of the 8 in.×10 in. X-ray mammograms 305 while a second barcode reader (not shown) is positioned to read the barcode 810 printed on the labels 800 of the 10 in.×12 in. films 305′. As one skilled in the art will appreciate, scanner 120 may alternatively implement additional barcode readers or even one barcode reader to scan the labels 800 of both the 8 in.×10 in. film 305 and the 10 in.×12 in. film 305′.

In one embodiment, the barcode readers may be positioned to read the labels of the films as they exit the scanner. For example, one barcode reader located at the right side of the film output slot could read the labels of the smaller films, while a second barcode reader at the left side of the output slot could read the labels of the larger films. As one skilled in the art will appreciate, the barcode reads may be attached to the scanner in any number of locations. For instance, instead of reading the labels of the mammograms as they exit the scanner, the barcode readers could be positioned to read the labels as the mammograms are received into the scanner. Moreover, the readers may be located in the scanner itself.

Furthermore, as discussed above, the orientation of the label 800 on the X-ray mammogram may vary depending on the type and location of the label scanner(s). For example, the scanner 120 may be configured to read labels 800 placed at the top left of the larger film sizes and at the bottom center of the smaller film sizes.

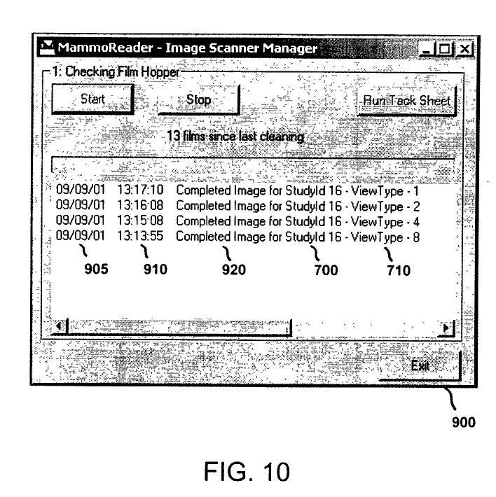

During the scanning process the X-ray mammogram is converted into a digital image and the information on the label 800 is read and stored in one or more databases 180, as depicted in FIG. 5. In particular, the system may store and track the digital images according to the associated Study ID 700 and Film View 710. For example, FIG. 10 shows an exemplary user interface 900 for managing the scanning process. Specifically, the exemplary window 900 shows the date 905 and time 910 each X-ray mammogram was scanned. Moreover, the status window 900 shows the Study ID 700 and Film View 710 read from the X-ray mammogram and now associated with the corresponding digital image. Finally, the status 920 of the scanning operation is displayed in window 900.

After an X-ray 305 has been successfully scanned and stored according to the tracking information, the system may analyze the digital images using one or more CAD techniques known in the art. The system of the present embodiment also tracks the CAD results according to the Study ID 700 and Film View 710 associated with the digital image. As previously discussed, the digital mammograms are normally analyzed using CAD routines to detect and identify abnormalities or suspicious structures.

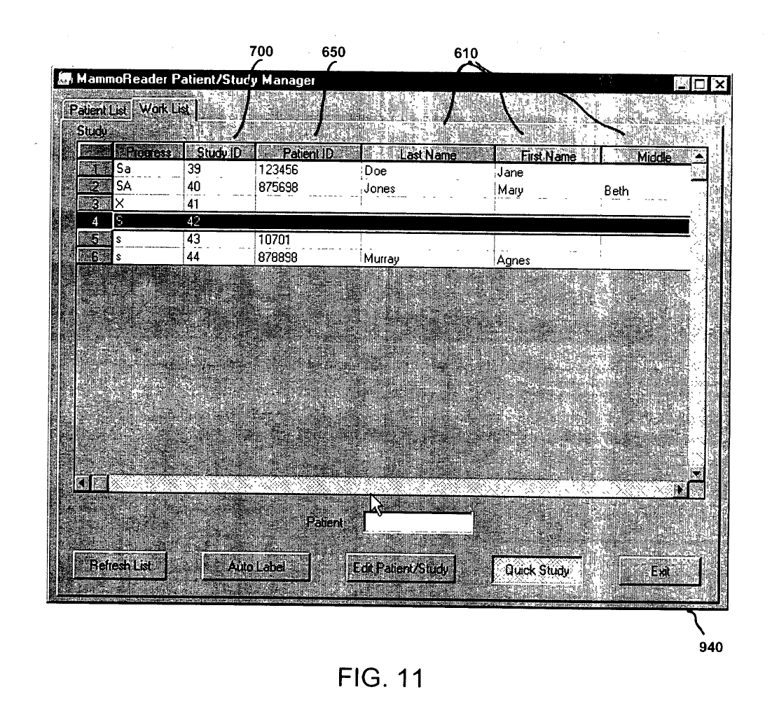

FIG. 11 shows an exemplary user interface 940 for managing the CAD operation. Specifically, FIG. 11 shows the Study ID 700, the Patient ID 650 (if previously entered), and the name 610 of the patient. If the mammogram was not properly digitized or the label 800 was not read by scanner 120, the study manager window 940 may indicate that an error occurred in the scanning process.

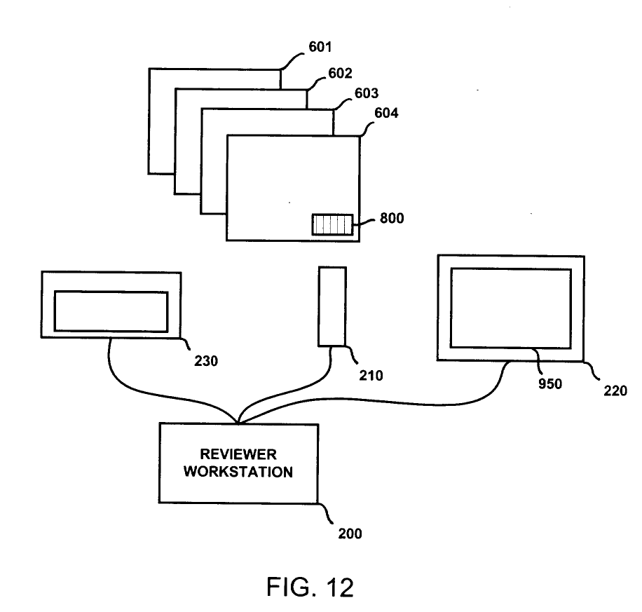

Again, referring to FIG. 5, after a study has been scanned and analyzed, one or more images of the study may be retrieved 190 and displayed 195. Since the present embodiment provides a reliable method and system for associating and tracking the original mammograms and the corresponding CAD results, a radiologist may easily and reliably retrieve the patient's study. At depicted in FIG. 12, a radiologist will typically view one or more of the original X-ray mammograms on a lightbox (not shown), monitor, or other viewing device. To aid the radiologist in the evaluation process, the present embodiment provides an efficient method and system for retrieving and displaying any corresponding CAD results. While viewing the original mammograms 601-604 at a reviewer workstation 200, the radiologist may simply input the Study ID 700 and View identifier 710 from one of the films into the tracking system of the present embodiment. The system then retrieves from one or more databases the corresponding digital images and/or CAD results. The retrieved images may be displayed on one or more monitors 220 attached to the workstation 200. Alternatively, the stored images may be printed or outputted using any type of desired output device.

As shown in the exemplary reviewer workstation shown in FIG. 12, at the reviewer workstation 200 the radiologist may simply input the tracking information from one of the four mammograms 601-604 into the system of the present invention. In the present embodiment, the reviewer workstation 200 is configured with a barcode gun 210. Therefore, the radiologist may simply scan a barcode printed on one of the tracking labels 800. Alternatively, the radiologist may display the digital image of one or more of the X-ray films and then scan the barcode displayed on the monitor to retrieve the corresponding CAD results. As mentioned before, the barcode 800 preferably identifies the Study ID 700 and Film View 710. Using the tracking information, the system of the present embodiment retrieves the CAD results for the study (i.e., all of the mammograms of the study) and displays the images in the viewing area 950 of monitor 220.

Alternatively, as one skilled in the art will appreciate, other input devices may be used for inputting the tracking information into the system of the present invention. For example, the radiologist may simply use an attached keyboard 230, microphone, or other input device to call-up the patient's study. As mentioned earlier, the input device used may depend on the type of label applied to films 601-604. For instance, if labels are printed with a barcode, then a standard barcode reader 210 may be efficiently employed. As one skilled in the arty will appreciate, the present embodiment is not limited to a particular type of label or a particular input device.

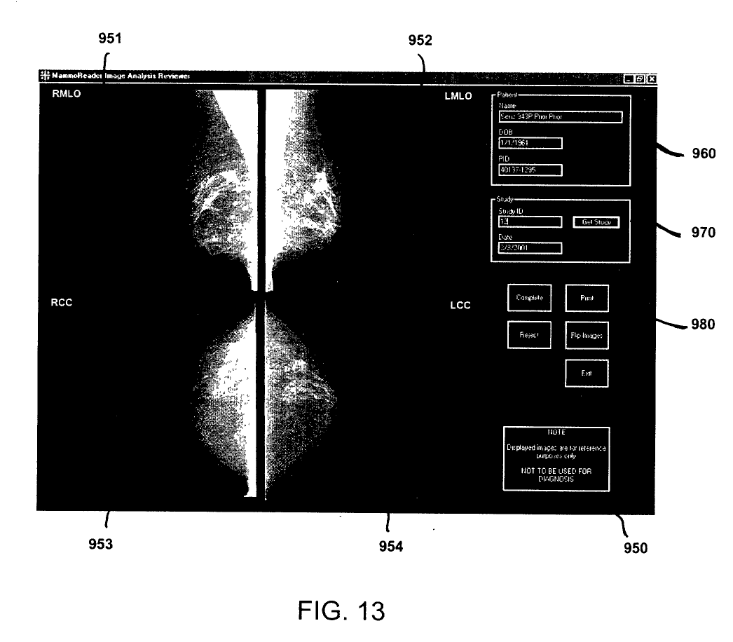

FIG. 13 shows an exemplary viewing area 950 displaying the CAD results. As shown in FIG. 13, the CAD results corresponding to the four original X-ray mammograms may be displayed according to their image view. For example, the CAD analysis for views RMLO, LMLO, RCC, and LCC may be respectively displayed in regions 951, 952, 953, and 954 of FIG. 13. As one skilled in the art will appreciate, the order in which the CAD results are displayed may be varied and the number of images displayed may be varied. For example, a radiologist may scan the barcode applied to an X-ray mammogram for purposes of displaying and evaluating only one image of the study. In addition to the CAD results, patient information 960, study information 970, and operating functions 980 may be displayed in the viewing area 950.

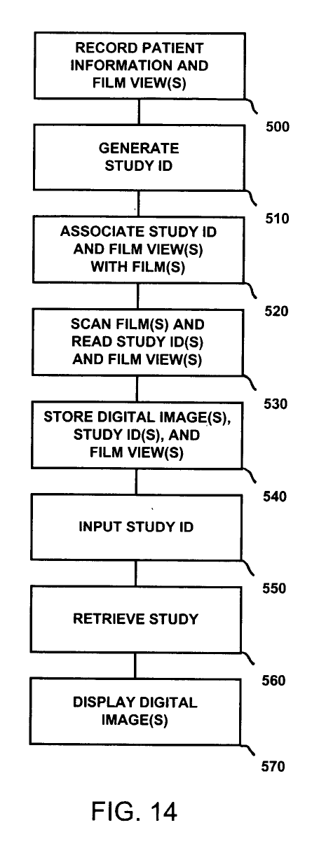

FIG. 14 shows in more detail the process for tracking radiological films and corresponding CAD results, according to one embodiment of the present invention. First, at step 500, relevant patient information is recorded and stored in one or more databases. Then at the step 510 of FIG. 14, the system generates a Study ID or another identifier for tracking the patient's study. At step 520 of FIG. 14, the Study ID and view information are associated with each X-ray mammogram of the study. The tracking information may applied to the X-ray mammograms using any number of techniques. For example, instead of using labels, the tracking information may be etched or directly printed onto the original X-ray mammogram. Furthermore, the tracking information may be included in the flasher when the film is exposed.

After the system digitizes the X-ray mammograms and reads the Study ID 700 at step 530, the digital images are tracked and stored according to the associated Study ID 700 and Film View 710, as indicated by step 540 in FIG. 14. The at step 550, a radiologist may input the Study ID 700 and View identifier 710 from one of the films into the tracking system of the present embodiment. The system then retrieves one or more images associated with the study at step 560. Finally, the retrieved images are then displayed or outputted at step 570 of FIG. 14.

In an alternative embodiment, the radiologist or other user may retrieve the CAD results using other identifying information that may have been associated with a patient's study. For example, if a Patient ID 650 was assigned to the patient, inputted into the tracking system, and somehow indicated on the label of the X-ray mammogram, then the radiologist could use the Patient ID to call-up the patient's study.

Furthermore, as one skilled in the art will appreciate, the method illustrated in FIG. 14 must not be performed in the sequence shown. For instance, the patient's information may be entered and recorded after the X-ray mammograms have been scanned and entered into the tracking system of the present embodiment.

It will be apparent to those skilled in the art that various modifications and variations can be made in the method and system for processing mammographic films and for tracking associated digital images. For example, the techniques described herein may be used in connection with other radiological studies, such as magnetic resonance imaging, positron emission topography, sonic and ultrasonic images, to name a few. Thus, it is intended that the present invention cover the modifications and variations of this invention provided they come within the scope of the appended claims and their equivalents.

What is claimed is:

1. A system for tracking medical images and associated digital images for diagnostic evaluation, the system comprising:
a scanner for digitizing one or more medical images defining a case to thereby produce one or more digitized medical images and for reading a machine-readable tracking identifier attached to each medical image of the case;
a server for associating the tracking identifier with one or more digitized medical images and one or more computer-aided diagnostic (CAD) images, wherein the one or more CAD images correspond to the one or more digitized medical images that are processed using a CAD algorithm; and
a storage device for storing the associated tracking identifier, the one or more digitized medical images, and the one or more CAD images,
wherein the server receives and processes a medical image request including the tracking identifier to retrieve at least one of the one or more digitized medical images or the one or more CAD images from the storage device using the tracking identifier.

2. The system of claim 1, wherein the medical images include X-ray mammograms.

3. The system of claim 1, wherein the server performs CAD processing of the one or more digitized medical images to produce the CAD images.

4. The system of claim 1, wherein the scanner includes at least one reader for reading the machine-readable tracking identifier.

5. The system of claim 1, wherein the tracking identifier is attached to each medical image of the case using a label.

6. The system of claim 5, wherein the label further includes a view ID that identifies a view type corresponding to the view type of the medical image.

7. The system of claim 5, further comprising a printer for printing the tracking identifier on the label.

8. The system of claim 1, wherein the machine-readable tracking identifier is a barcode and wherein the scanner includes a barcode reader for reading the barcode.

9. The system of claim 1, wherein the tracking identifier includes a unique case ID that identifies a patient.

10. The system of claim 1, wherein the server further generates the tracking identifier.

11. The system of claim 1, wherein the tracking identifier is the same for each of the medical images of the study.

12. The system of claim 1, wherein the server includes one or more of a barcode reader, a keyboard, a network interface, and a microphone.

13. The system of claim 1, further comprising a monitor for displaying the one or more digital images retrieved from the storage device.

14. A method for scanning and tracking medical images using a scanning system, the system comprising:
receiving one or more medical images, wherein each medical image has a machine-readable label containing at least one tracking identifier;
scanning the one or more medical images and the at least one tracking identifier, whereby said medical image is digitized and the at least one tracking identifier on said machine-readable label is read;
associating the at least one tracking identifier with the digitized medical image; and
storing the at least one tracking identifier and the digitized medical image in at least one storage device.

15. The method of claim 14, wherein the medical images include mammograms.

16. The method of claim 14, wherein the one or more medical images include a first medical image measuring 8 inches by 10 inches and a second medical image measuring 10 inches by 12 inches.

17. The method of claim 14, wherein the one or more medical images are received from a hopper of the scanner, the hopper having one or more image guides, and wherein the step of scanning medical images is performed without adjusting the one or more image guides of the hopper.

18. The method of claim 14, further comprising printing the at least one tracking identifier on the machine-readable label using a printer attached to said scanning system.

19. The method of claim 14, wherein the tracking identifier includes a case ID that identifies a patient and a view ID that identifies a view type corresponding to the view type of the medical image.

20. The method of claim 14, wherein each medical image having a machine-readable label includes a rectangular-shaped mammogram having a glossy side and depicting a breast image, and wherein the machine-readable label is located at a bottom right portion of the glossy side when the breast image is pointing downward.

21. The method of claim 20, wherein the bottom right portion includes the bottom right edge adjacent to a comer of the rectangular-shaped mammogram.

22. The method of claim 14, wherein the machine-readable label includes a barcode label.

23. The method of claim 14, further comprising associating results of a CAD analysis of the digitized medical image with the tracking identifier.

24. The method of claim 14, wherein the step of receiving one or more medical images includes receiving one or more medical images loaded into a hopper of the scanning system.

25. The method of claim 24, wherein the medical images are received from the hopper without human intervention.

26. The method of claim 14, wherein the one or more medical images are automatically scanned.

27. The method of claim 14, wherein the digitizing of the medical image and the reading of the machine-readable label are performed in a single scanning operation.

28. A system for tracking medical images and associated digital images for diagnostic evaluation, the system comprising:
a means for digitizing one or more medical images defining a case to thereby produce one or more digitized medical images and for reading a machine-readable tracking identifier attached to each medical image of the case;
a means for associating the tracking identifier with one or more digitized medical images and one or more computer-aided diagnostic (CAD) images, wherein the one or more CAD images correspond to the one or more digitized medical images that are processed using a CAD algorithm; and
a means for storing the associated tracking identifier, the one or more digitized medical images, and the one or more CAD images,
wherein the means for storing receives and processes a medical image request including the tracking identifier to retrieve at least one of the one or more digitized medical images or the one or more CAD images using the tracking identifier.

29. The system of claim 28, further comprising means for displaying at least one of the one or more digitized medical images or the one or more CAD images.
